(19) United States
(12) Patent Application Publication
(10) Pub. No.: US 2021/0189984 A1
(43) Pub. Date: Jun. 24, 2021

(54) METHOD AND SYSTEM FOR RECOVERING VEHICLE LAMBDA SENSORS WITH AN EXTERNAL AIR SUPPLY

(71) Applicant: Volvo Car Corporation, Göteborg (SE)

(72) Inventors: Niklas Särnberger, Göteborg (SE); Sasa Trajkovic, Göteborg (SE); Andreas Storm, Göteborg (SE); Amir Toma, Göteborg (SE); Niklas Hansson, Göteborg (SE)

(21) Appl. No.: 17/122,387

(22) Filed: Dec. 15, 2020

Related U.S. Application Data
(60) Provisional application No. 62/952,709, filed on Dec. 23, 2019.

(51) Int. Cl. F02D 41/14; F01N 3/20; F01N 9/00; F01N 11/00

(52) U.S. Cl. CPC F02D 41/1494; F02D 41/1454; F02D 41/1441; F01N 3/20; F01N 2560/025; F01N 11/007; F01N 2900/1402; F01N 2560/20; F01N 9/00

(57) ABSTRACT

The present disclosure carefully controls the heating duty cycle of a Lambda sensor, utilizing higher heating temperatures during lean phases, such as a fuel cutoff event or the like. Essentially, there is a calibration routine that is executed via software and allows a Lambda sensor to at least one of preserve full function over time and recover from an erroneous state. Advantageously, Lambda sensor life expectancy is increased accordingly. Optionally, the heating temperature for the Lambda sensor is selectively increased by increasing an applied voltage to the Lambda sensor.

### CROSS-REFERENCE TO RELATED APPLICATION

The present disclosure claims the benefit of priority of co-pending U.S. Provisional Patent Application No. 62/952,709, filed on Dec. 23, 2019, and entitled “METHOD AND SYSTEM FOR RECOVERING VEHICLE LAMBDA SENSORS WITH AN EXTERNAL AIR SUPPLY,” the contents of which are incorporated in full by reference herein.

### TECHNICAL FIELD

The present disclosure relates generally to the automotive field. More particularly, the present disclosure relates to a method and system for recovering vehicle Lambda sensors with an external air supply.

### BACKGROUND

Most vehicles powered by an internal combustion engine (ICE) utilize one or more Lambda (O₂) sensors in their exhaust emissions systems. In general, a Lambda sensor works together with a vehicle's fuel injection system, catalytic converter, and engine management system (EMS) or electronic control unit (ECU) to help achieve the lowest possible output of environmentally harmful engine emissions. The Lambda sensor monitors the percentage of unburned O₂ present in the vehicle's exhaust gases. The Lambda sensor, responsive to the detection of a lean mixture with too high an O₂ content or a rich mixture with too low an O₂ content, transmits an appropriate voltage signal to the ECU, which then adjusts the air/fuel ratio entering the catalytic converter. The goal is to keep the air/fuel ratio very close to a “stoichiometric” point, which is the calculated ideal air/fuel ratio entering the catalytic converter. Lambda sensors can be utilized at multiple points before and after the catalytic converter. Theoretically, at the “stoichiometric” point, all of the fuel will be burned using almost all of the O₂ in the air, and the remaining O₂ will be exactly the right quantity for the catalytic converter to function efficiently.

A typical Lambda sensor includes a hollow zirconium dioxide sensor element. The inner side of the sensor element is in contact with the ambient air, while the outer side is in the exhaust gas flow. Both sides are coated with a thin porous platinum layer that acts as an electrode. When the zirconium dioxide sensor element reaches its operating temperature, O₂ ions start to flow based on the concentration gradient. O₂ ions move from the reference side in the direction of the exhaust gas to balance this out. This creates a voltage potential difference and a voltage is applied to the connected platinum electrodes. In contrast, titanium dioxide sensors do not produce any voltage. Rather, their resistance changes commensurate with the residual O₂ concentration in the exhaust gas. Thus, reference air is not required.

An important part of any engine control software in the ECU is the exhaust emissions system controlling engine operation to meet legislated emissions requirements. An important function of this exhaust emissions system is to enrich the catalyst after a fuel cutoff event or the like, when the catalyst is saturated with O₂. If the timing of this catalyst enrichment is slightly off, then emissions will rapidly increase. Catalyst enrichment is realized by lowering the target Lambda to a rich air/fuel mixture (typically about 0.8), where the lambda is an air-fuel equivalence ratio that is the ratio of the actual air-fuel ratio to the air-fuel ratio at the stoichiometric point. Thus, the Lambda is controlled by the Lambda controller during the catalyst enrichment phase to ensure correct timing of the catalyst enrichment.

Disadvantageously, many Lambda sensors become downwards limited and cannot read rich air/fuel ratios below about 0.95 after a fuel cutoff event or the like. This is a hardware problem that has not been rectified and results in wrong calculations and unacceptable tailpipe emissions exceeding legislative requirements after a fuel cutoff event or the like. This issue is dealt with by the present disclosure.

### SUMMARY

In general, the present disclosure carefully controls the heating duty cycle of a Lambda sensor, utilizing higher heating temperatures during lean phases, such as a fuel cutoff event or the like. Essentially, there is a calibration routine that is executed via software and allows a Lambda sensor to preserve full function over time and to recover from an erroneous state. In particular, controlling the heating duty cycle for the Lambda sensor by increasing the heating temperature during lean phases allows the Lambda sensor to recover from an erroneous state where rich Lambda measurement is limited and in some instances, preservers full function of the Lambda sensor over time by preventing the Lambda sensor from falling into the erroneous state.

In some embodiments, Lambda sensor recovery is obtained by increasing a heating temperature of the heater element. This Lambda sensor recovery is applied at lean fuel events, such as fuel cutoff events, in-vehicle after run or “start/stop” engine shut off events, and the like. This recovery can be used without affecting operation of the Lambda sensor during general operation of the vehicle and can be controlled to maintain operation thereof below a destructive limit. This recovery can also be used without effecting alteration of sensor Lambda value readings that would lead to higher tailpipe emissions. If this method is applied from new, the probability of the Lambda sensor keeping its life expectancy will increase.

As is conventional, the heated Lambda sensor has an internal heater circuit that brings the Lambda sensor up to operating temperature more quickly than an unheated Lambda sensor, for example, within 20 to 60 seconds, depending on the Lambda sensor, and keeps the Lambda sensor hot even when the engine is idling for a long period of time. The faster the Lambda sensor heats up, the quicker the system can enter closed loop fuel control, optimizing catalytic converter efficiency.

In accordance with the present disclosure, higher heating element temperatures are utilized during lean phases, such as a fuel cutoff event or the like. Further, an applied voltage of the Lambda sensor can also be increased to increase the heating temperature for the Lambda sensor. This can be performed separate or in conjunction with an increase in temperature of the heating element. Further, the heating temperature of the Lambda sensor may be a function of a heating duty cycle increase amount during a Lambda shift to a rich fuel to air ratio.

In one illustrative embodiment, the present disclosure provides a vehicle exhaust emissions control method implemented responsive to a fuel cutoff event or the like. The method includes detecting a fuel limiting event resulting in a reduced air/fuel ratio in an exhaust emissions system of a vehicle, the reduced air/fuel ratio potentially faulting a Lambda sensor disposed in the exhaust emissions system. The method also includes selectively increasing a heating temperature for the Lambda sensor responsive to the reduced air/fuel ratio, thereby performing one of preserving full function of the Lambda sensor during the fuel limiting event and recovering a faulting of the Lambda sensor during the fuel limiting event.

In one embodiment, the heating temperature for the Lambda sensor is increased using a heating element coupled to an electronic control unit of the vehicle. Optionally, the heating temperature for the Lambda sensor is also increased by increasing an applied voltage to the Lambda sensor.

In some embodiments, the electronic control unit is further adapted to control operation of an engine of the vehicle. The electronic control unit is further adapted to control operation of a catalytic converter of the vehicle. The Lambda sensor is disposed at one of upstream of the catalytic converter and downstream of the catalytic converter.

In another embodiment, the heating temperature for the Lambda sensor is at least partially increased by increasing an applied voltage to the Lambda sensor.

In a further embodiment, the heating temperature for the Lambda sensor is a function of a heating duty cycle increase amount during a Lambda shift to a rich fuel to air ratio.

In another illustrative embodiment, the present disclosure provides a non-transitory computer-readable medium stored in a memory and executed by a processor to control vehicle exhaust emissions responsive to a fuel cutoff event or the like, performing the steps comprising: detecting a fuel limiting event resulting in a reduced air/fuel ratio in an exhaust emissions system of a vehicle, the reduced air/fuel ratio potentially faulting a Lambda sensor disposed in the exhaust emissions system; and selectively increasing a heating temperature for the Lambda sensor responsive to the reduced air/fuel ratio, thereby performing one of preserving full function of the Lambda sensor during the fuel limiting event and recovering a faulting of the Lambda sensor during the fuel limiting event.

In one embodiment, the heating temperature for the Lambda sensor is increased using a heating element coupled to an electronic control unit of the vehicle.

In some embodiments, the electronic control unit is further adapted to control operation of an engine of the vehicle. The electronic control unit is further adapted to control operation of a catalytic converter of the vehicle. The Lambda sensor is disposed at one of upstream of the catalytic converter and downstream of the catalytic converter.

In another embodiment, the heating temperature for the Lambda sensor is at least partially increased by increasing an applied voltage to the Lambda sensor.

In a further embodiment, the heating temperature for the Lambda sensor is a function of a heating duty cycle increase amount during a Lambda shift to a rich fuel to air ratio.

In a further illustrative embodiment, the present disclosure provides a vehicle exhaust emissions control system actuated responsive to a fuel cutoff event or the like. The exhaust emissions control system includes a lambda sensor and an electronic control unit. The Lambda sensor is disposed in an exhaust emissions system. The electronic control unit is adapted to (1) detect a fuel limiting event resulting in a reduced air/fuel ratio in the exhaust emissions system of a vehicle, the reduced air/fuel ratio potentially faulting the Lambda sensor and (2) selectively increasing a heating temperature for the Lambda sensor responsive to the reduced air/fuel ratio, thereby performing one of preserving full function of the Lambda sensor during the fuel limiting event and recovering a faulting of the Lambda sensor during the fuel limiting event.

In one embodiment, the vehicle exhaust emissions control system further includes a heating element coupled to the electronic control unit adapted to increase the heating temperature for the Lambda sensor in response to an instruction received from the electronic control unit that is provided responsive to the reduced air/fuel ratio. Optionally, the heating temperature for the Lambda sensor is also increased by increasing an applied voltage to the Lambda sensor.

In some embodiments, the electronic control unit is further adapted to control operation of an engine of the vehicle. The electronic control unit is further adapted to control operation of a catalytic converter of the vehicle. The Lambda sensor is disposed upstream of the catalytic converter. Alternatively, the Lambda sensor is disposed downstream of the catalytic converter.

In another embodiment, the heating temperature for the Lambda sensor is at least partially increased by increasing an applied voltage to the Lambda sensor.

In a further embodiment, the heating temperature for the Lambda sensor is a function of a heating duty cycle increase amount during a Lambda shift to a rich fuel to air ratio.

### BRIEF DESCRIPTION OF THE DRAWINGS

The present disclosure is illustrated and described herein with reference to the various drawings, in which like reference numbers are used to denote like method steps/system components, as appropriate, and in which:

FIG. 1 is a schematic diagram illustrating one illustrative embodiment of the exhaust emissions system of the present disclosure, implementing a novel Lambda sensor heating routine in the event of s fuel cutoff event or the like;

FIG. 2 is a flowchart illustrating one illustrative embodiment of the exhaust emissions method of the present disclosure, implementing a novel Lambda sensor heating routine in the event of s fuel cutoff event or the like;

FIG. 3 is plot illustrating one illustrative embodiment of the exhaust emissions scheme of the present disclosure, implementing a novel Lambda sensor heating routine in the event of s fuel cutoff event or the like; and

FIG. 4 is a block diagram of the Electronic Control Unit (ECU) of FIG. 1.

### DESCRIPTION OF EMBODIMENTS

Again, the present disclosure carefully controls the heating duty cycle of a Lambda sensor, utilizing higher heating temperatures during lean phases, such as a fuel cutoff event or the like to recover the Lambda sensor from an erroneous event and to ensure that the Lambda sensor operates within a proper operating temperature range during lean phases, such as lean fuel events. Essentially, there is a calibration routine that is executed via software and allows a Lambda sensor to recover from an erroneous state. By controlling the heating duty cycle for the Lambda sensor heating the Lambda sensor at higher temperatures allows the Lambda sensor to recover from an erroneous state where rich Lambda measurement is limited. Lambda sensor recovery can be obtained by increasing heater element temperatures at lean fuel events, such as fuel cutoff events, in-vehicle after run, “start/stop” engine shut off events, and the like. This heating operation for Lambda sensor recovery at lean fuel events can be used without effecting normal operation of the Lambda sensor (during general operation/non-lean fuel events). This recovery can be used without affecting operation of the Lambda sensor during general operation of the vehicle and can be controlled to maintain operation thereof below a destructive limit. This recovery can also be used without effecting alteration of sensor Lambda value readings that would lead to higher tailpipe emissions. Further, if this method is applied when a new Lambda sensor is installed, the probability of the Lambda sensor keeping its life expectancy will increase.

As is conventional, the heated Lambda sensor has an internal heater circuit that brings the Lambda sensor up to a general operating temperature more quickly than an unheated Lambda sensor, for example, within 20 to 60 seconds, depending on the Lambda sensor, and keeps the Lambda sensor hot (at the general operating temperature) even when the engine is idling for a long period of time. The faster the Lambda sensor heats up, the quicker the system can enter closed loop fuel control, optimizing catalytic converter efficiency. In accordance with the present disclosure, higher heating temperatures are utilized during lean phases, such as a fuel cutoff event or the like. In particular, the heating temperature is set at a higher heating temperature during a lean fuel event than the general heating temperature maintained during general operation of the Lambda sensor during non-lean fuel events, such as during general operation of the vehicle.

To aid in the recovery of the Lambda sensor during a lean fuel event, in some embodiments, the applied voltage to the Lambda sensor is increased. In embodiments, the applied voltage provides at least a portion of the heating temperature increase during the recovery of the Lambda sensor. Thus, advantageously, full recovery of the Lambda sensor can be obtained faster/easier with an increased applied voltage to the Lambda sensor in combination with an increase in the heating temperature applied by a heating element.

Full recovery of the Lambda sensor is also aided by operation of the vehicle at a lean Lambda prior to and during a lean fuel event. Thus, in some embodiments, the vehicle is transitioned to a lean Lambda operation in response to a predicted lean fuel event and prior to the occurrence of the lean fuel event.

Further, to ensure that the Lambda sensor is not damaged and to maintain a life expectancy of the Lambda sensor, in some embodiments, the heating of the Lambda sensor during a lean fuel event is increased above the general operating temperatures of the heating element to recover the Lambda sensor, while being kept below a predetermined temperature that would significantly reduce the life cycle of the Lambda sensor, such as destructive heating temperatures for the Lambda sensor and temperatures that would cause the Lambda sensor to increase too much. Similarly, the heating duty of a heating element, while increased during a lean fuel event, is also maintained below a predetermined temperature that would significantly reduce a life cycle of the heating element.

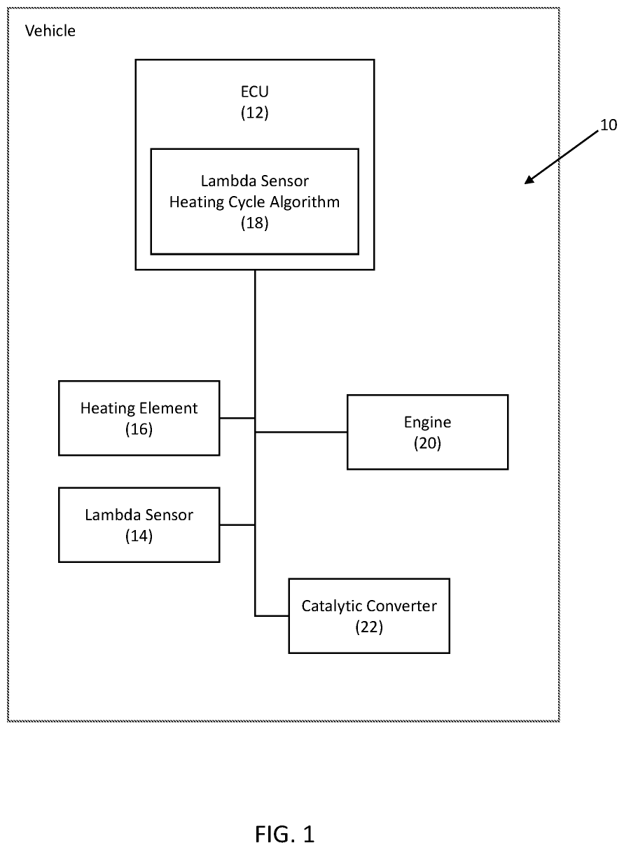

Referring now specifically to FIG. 1, in one illustrative embodiment, the exhaust emissions system 10 of the present disclosure includes the ECU 12 which is electrically coupled to the Lambda sensor 14 and a heating element 16. The ECU 12 is operable for executing a Lambda sensor heating cycle algorithm 18 in the event of a fuel cutoff event or the like, when it is expected that the air/fuel ratio will suddenly spike upwards. In such cases, the heating element 16 is actuated to increase a heating temperature for the Lambda sensor 14. This increase in heating temperature fully recovers a failed Lambda sensor, and in many instances, preserves full function of the Lambda sensor over time. Thus, the heating temperature for the Lambda sensor 14 is hotter than usual when the fuel is restored and the air/fuel ratio suddenly changes during a lean fuel event, for example. As described previously, under such circumstances, the Lambda sensor 14 normally fails to function properly, but this fault is now prevented by the novel heating routine. As is illustrated, the ECU 12 is also electrically coupled to the engine 20 of the vehicle, as well as the catalytic converter 22.

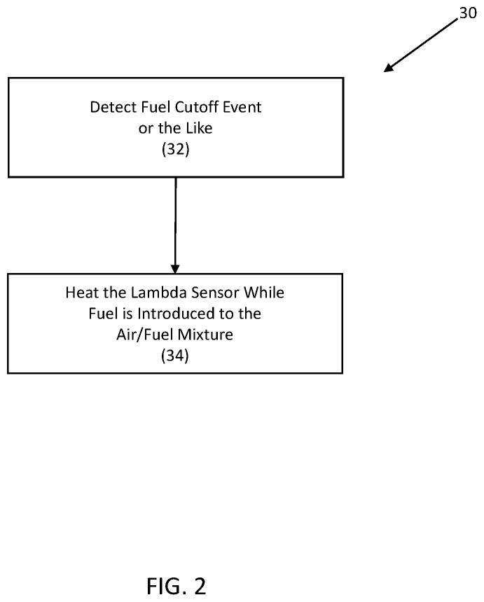

Referring now specifically to FIG. 2, in another illustrative embodiment, the exhaust emissions method 30 of the present disclosure includes, upon detecting a fuel cutoff event or the like 32, in which it is expected that the air/fuel ratio will suddenly spike upwards, the ECU 12 (FIG. 1) executes a Lambda sensor heating cycle algorithm 18 (FIG. 1) whereby a heating temperature of the Lambda sensor 14 (FIG. 1) is increased 34. The increase in the heating temperature of the Lambda sensor 14 (FIG. 1) results in a heating temperature that is higher while the air-fuel ratio is expected to spike than the heating temperature during general operation of the Lambda sensor, such as during non-lean fuel events and general operation of the vehicle. Thus, the Lambda sensor 14 is heated by a higher than usual heating temperature to preserves full function of the Lambda sensor over time and to recover a failed Lambda sensor. Under such circumstances, the Lambda sensor 14 normally fails to function properly, but this fault is now prevented by the novel heating routine.

In embodiments, the heating temperature of the Lambda sensor 14 (FIG. 1) is increased by increasing a heating duty cycle of the heating element 16 (FIG. 1), which is actuated to increase the heating temperature supplied to the Lambda sensor 14 (FIG. 1).

In embodiments, the heating temperature of the Lambda sensor 14 (FIG. 1) is at least partially increased by increasing a voltage applied to the Lambda sensor 14 (FIG. 1). In these embodiments, and in particular where both the heating duty cycle of the heating element 16 (FIG. 1) and the applied voltage to the Lambda sensor 14 (FIG. 1) is increased, preservation of full function of the Lambda sensor can be easier to maintain and full recovery of a failed Lambda sensor can be obtained faster.

In embodiments, the heating temperature of the Lambda sensor 14 (FIG. 1) during a fuel limiting event is a function of a heating duty cycle increase amount during a Lambda shift to a rich fuel to air ratio.

In embodiments, the heating temperature of the Lambda sensor 14 (FIG. 1) is further maintained below a predetermined temperature. The predetermined temperature is at least one of a temperature that would significantly reduce the life cycle of the Lambda sensor, such as destructive heating temperatures for the Lambda sensor and temperatures that would cause the Lambda sensor to increase too much and temperature that would significantly reduce a life cycle of the heating element. In some embodiments, the predetermined temperature is selected based on the type and materials of the Lambda sensor and/or the heating element.

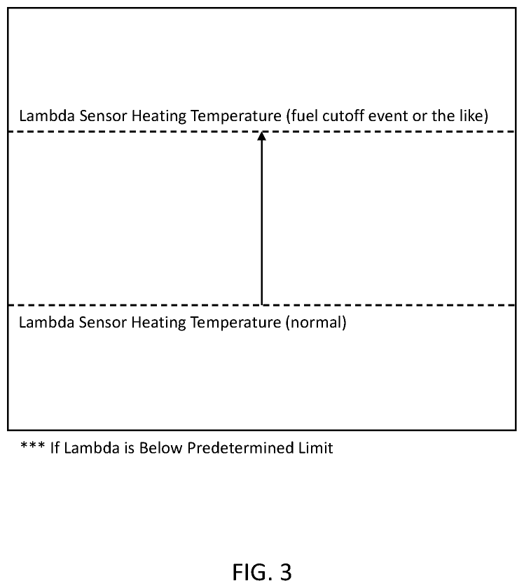

FIG. 3 illustrates the Lambda sensor heating profile utilized responsive to a fuel cutoff event or the like in accordance with the present disclosure.

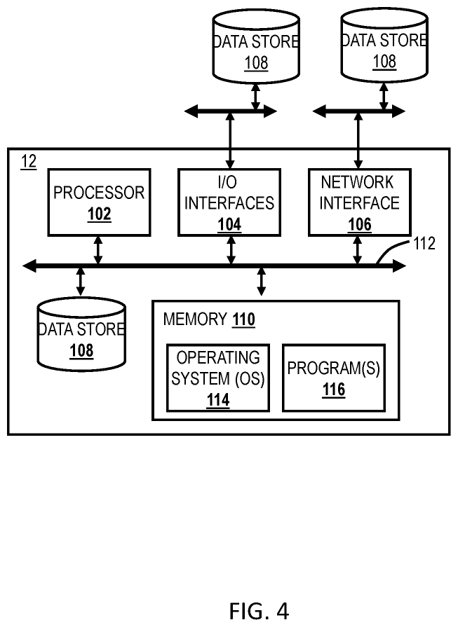

FIG. 4 is a block diagram of the ECU 14 of FIG. 1. In embodiments, the ECU 14 and the components thereof are configured to implement the exhaust emissions method of the present disclosure. While an ECU 14 is described, other controllers with similar hardware/software configurations are also contemplated. In the embodiment illustrated, the processor 102 is a hardware device for executing software instructions embodied in a non-transitory computer-readable medium.

The processor 102 may be any custom made or commercially available processor, a central processing unit (CPU), an auxiliary processor among several processors associated with a server, a semiconductor-based microprocessor (in the form of a microchip or chipset), or generally any device for executing software instructions. When the ECU 12 is in operation, the processor 102 is configured to execute software stored within the memory 110, to communicate data to and from the memory 110, and to generally control operations of the ECU 12 pursuant to the software instructions.

I/O interfaces 104 may be used to receive user input from and/or for providing system output to one or more devices or components. A network interface 106 may be used to enable the ECU 12 to communicate on a network, such as the Internet or a Local Area Network (LAN).

The network interface 106 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 106 may include address, control, and/or data connections to enable appropriate communications on the network.

A data store 108 may be used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media. In one example, the data store 108 may be located internal to the ECU 12, such as, for example, an internal hard drive connected to the local interface 112 in the ECU 12. Additionally, in another embodiment, the data store 108 may be located external to the control system 100 such as, for example, an external hard drive connected to the I/O interfaces 104 (e.g., a SCSI or USB connection).

In a further embodiment, the data store 108 may be connected to the ECU 12 through a network, such as, for example, a network-attached file server. The memory 110 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 110 may incorporate electronic, magnetic, optical, and/or other types of storage media. Note that the memory 110 may have a distributed architecture, where various components are situated remotely from one another but can be accessed by the processor 102. The software in memory 110 may include one or more software programs, each of which includes an ordered listing of executable instructions for implementing logical functions. The software in the memory 110 includes a suitable operating system (O/S) 114 and one or more programs 116. The operating system 114 essentially controls the execution of other computer programs, such as the one or more programs 116, and provides scheduling, input-output control, file and data management, memory management, and communication control and related services. The one or more programs 116 may be configured to implement the various processes, algorithms, methods, techniques, etc. described herein.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit, such as ECU 12. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) a tangible computer-readable storage medium that is non-transitory or (2) a communication medium, such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include random-access memory (RAM), read-only memory (ROM), electrically erasable-programmable read-only memory (EEPROM), compact disc read-only memory (CD-ROM) or other optical disc storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared (IR), radio frequency (RF), and microwave, then the coaxial cable, fiber optic cable, twisted pair, DSL, or wireless technologies, such as IR, RF, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), complex programmable logic devices (CPLDs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Although the present disclosure is illustrated and described herein with reference to preferred embodiments and specific examples thereof, it will be readily apparent to persons of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims for all purposes.

What is claimed is:

1. A vehicle exhaust emissions control method, comprising:
detecting a fuel limiting event resulting in a reduced air/fuel ratio in an exhaust emissions system of a vehicle, the reduced air/fuel ratio potentially faulting a Lambda sensor disposed in the exhaust emissions system; and
selectively increasing a heating temperature for the Lambda sensor responsive to the reduced air/fuel ratio, thereby performing one of preserving full function of the Lambda sensor during the fuel limiting event and recovering a faulting of the Lambda sensor during the fuel limiting event.

2. The method of claim 1, wherein the heating temperature for the Lambda sensor is increased using a heating element coupled to an electronic control unit of the vehicle.

3. The method of claim 2, wherein the heating temperature for the Lambda sensor is also increased by increasing an applied voltage to the Lambda sensor.

4. The method of claim 2, wherein the electronic control unit is further adapted to control operation of an engine of the vehicle.

5. The method of claim 2, wherein the electronic control unit is further adapted to control operation of a catalytic converter of the vehicle.

6. The method of claim 5, wherein the Lambda sensor is disposed at one of upstream of the catalytic converter and downstream of the catalytic converter.

7. The method of claim 1, wherein the heating temperature for the Lambda sensor is at least partially increased by increasing an applied voltage to the Lambda sensor.

8. The method of claim 1, wherein the heating temperature for the Lambda sensor is a function of a heating duty cycle increase amount during a Lambda shift to a rich fuel to air ratio.

9. A non-transitory computer-readable medium stored in a memory and executed by a processor to control vehicle exhaust emissions by performing the steps comprising:
detecting a fuel limiting event resulting in a reduced air/fuel ratio in an exhaust emissions system of a vehicle, the reduced air/fuel ratio potentially faulting a Lambda sensor disposed in the exhaust emissions system; and
selectively increasing a heating temperature for the Lambda sensor responsive to the reduced air/fuel ratio, thereby performing one of preserving full function of the Lambda sensor during the fuel limiting event and recovering a faulting of the Lambda sensor during the fuel limiting event.

10. The non-transitory computer-readable medium of claim 9, wherein the heating temperature for the Lambda sensor is increased using a heating element coupled to an electronic control unit of the vehicle.

11. The non-transitory computer-readable medium of claim 10, wherein the heating temperature for the Lambda sensor is also increased by increasing an applied voltage to the Lambda sensor.

12. The non-transitory computer-readable medium of claim 10, wherein the electronic control unit is further adapted to control operation of an engine of the vehicle.

13. The non-transitory computer-readable medium of claim 10, wherein the electronic control unit is further adapted to control operation of a catalytic converter of the vehicle.

14. The non-transitory computer-readable medium of claim 13, wherein the Lambda sensor is disposed at one of upstream of the catalytic converter and downstream of the catalytic converter.

15. The non-transitory computer-readable medium of claim 9, wherein the heating temperature for the Lambda sensor is at least partially increased by increasing an applied voltage to the Lambda sensor.

16. The non-transitory computer-readable medium of claim 9, the heating temperature for the Lambda sensor is a function of a heating duty cycle increase amount during a Lambda shift to a rich fuel to air ratio.

17. A vehicle exhaust emissions control system, comprising:
a lambda sensor disposed in an exhaust emissions system; and
an electronic control unit adapted to (1) detect a fuel limiting event resulting in a reduced air/fuel ratio in the exhaust emissions system of a vehicle, the reduced air/fuel ratio potentially faulting the Lambda sensor and (2) selectively increase a heating temperature for the Lambda sensor responsive to the reduced air/fuel ratio, thereby performing one of preserving full function of the Lambda sensor during the fuel limiting event and recovering a faulting of the Lambda sensor during the fuel limiting event.

18. The system of claim 17, further comprising:
a heating element coupled to the electronic control unit adapted to increase the heating temperature for the Lambda sensor in response to an instruction received from the electronic control unit that is provided responsive to the reduced air/fuel ratio.

19. The system of claim 18, wherein the heating temperature for the Lambda sensor is also increased by increasing an applied voltage to the Lambda sensor.

20. The system of claim 17, wherein the heating temperature for the Lambda sensor is a function of a heating duty cycle increase amount during a Lambda shift to a rich fuel to air ratio.
